(19) United States
(12) Patent Application Publication
(10) Pub. No.: US 2023/0393588 A1
(43) Pub. Date: Dec. 7, 2023

(54) AIRCRAFT CONTROL WITH SCHEDULED ANGLE OF ATTACK

(71) Applicant: Joby Aero, Inc., Santa Cruz, CA (US)

(72) Inventors: Alex Stoll, Santa Cruz, CA (US); Gregor Veble Mikic, Santa Cruz, CA (US)

(21) Appl. No.: 18/302,543

(22) Filed: Apr. 18, 2023

Related U.S. Application Data
(60) Provisional application No. 63/332,268, filed on Apr. 18, 2022.

(51) Int. Cl. G05D 1/08; G05D 1/06; B64U 10/20

(52) U.S. Cl. CPC G05D 1/0808; G05D 1/0669; G05D 1/0676; B64U 10/20; B64U 2201/00

(57) ABSTRACT

A method for controlling an aircraft includes accessing input data indicative of at least airspeed of the aircraft and determining trim values based at least in part on the input data. The trim values includes an angle of attack trim value for the aircraft. The method also includes accessing data indicative of the trim values by a flight controller and controlling, using the flight controller, operation of the aircraft based at least in part on the trim values.

### CROSS-REFERENCE TO RELATED APPLICATION

The present application is related, and has right of priority, to U.S. Provisional Patent Application No. 63/332,268, which was filed on Apr. 18, 2022 in the United States Patent & Trademark Office and is incorporated by reference in its entireties for all purposes.

### FIELD

The present disclosure relates generally to controlling aircraft configured for vertical take-off and landing as well as horizontal flight.

### BACKGROUND

Vertical takeoff and landing (VTOL) aircraft can undergo a conversion process during takeoff and landing, during which the physical and the flight control scheme of the aircraft changes. Providing adequate performance and control during the entire conversion process can be challenging. In conventional tiltrotor aircraft, a pilot manually controls shaft angle, power output (or collective pitch), and angle of attack to manage forces in the longitudinal and vertical direction and accelerate, decelerate, climb, descend, etc., which can be advantageous in dynamic settings. However, such tiltrotor aircraft must allow for adequate control and performance over a range of different airspeeds, shaft angles, and angles of attack, which is referred to as the “conversion corridor”. The conversion corridor must be wide enough to allow pilots to control the tiltrotor aircraft during takeoff and landing under a variety of conditions, which can place additional design constraints on the aircraft.

Systems and methods for operating VTOL aircraft with simplified piloting would be useful.

### SUMMARY

Aspects and advantages of embodiments of the present disclosure will be set forth in part in the following description, or may be learned from the description, or may be learned through practice of the embodiments.

In example embodiments, a method for controlling an aircraft includes: accessing input data indicative of at least airspeed of the aircraft; determining trim values based at least in part on the input data, the trim values comprising an angle of attack trim value for the aircraft; accessing data indicative of the trim values by a flight controller; and controlling, using the flight controller, operation of the aircraft based at least in part on the trim values.

In example embodiments, a system for controlling an aircraft includes one or more processors and one or more non-transitory computer-readable media that store instructions that are executable by the one or more processors to perform operations. The operations include: accessing input data indicative of at least airspeed of the aircraft; determining trim values based at least in part on the input data, the trim values comprising an angle of attack trim value for the aircraft; and controlling operation of the aircraft based at least in part on the trim values.

In example embodiments, an aircraft includes a flight controller and one or more actuators. The flight controller includes one or more processors and one or more non-transitory computer-readable media that store instructions that are executable by the one or more processors to perform operations. The operations includes: accessing input data indicative of at least airspeed of the aircraft; determining trim values based at least in part on the input data, the trim values comprising an angle of attack trim value for the aircraft; accessing data indicative of the trim values, and outputting an actuator command for controlling operation of the aircraft, via the one or more actuators, based at least in part on the trim values.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures.

FIG. 1 is a perspective view of an aircraft according to an example embodiment of the present disclosure in a thrust-borne flight regime.

FIG. 2 is a perspective view of the example aircraft of FIG. 1 in a horizontal flight configuration.

FIG. 3 is a perspective view of the example aircraft of FIG. 1 in a horizontal flight regime.

FIG. 4 is a side, elevation view of the example aircraft of FIG. 1 in a transition configuration.

FIG. 5 is a side, elevation view of the example aircraft of FIG. 1 in the thrust-borne flight regime.

FIG. 6 is a schematic view of a flight control system according to an example embodiment of the present disclosure.

FIG. 7 is a series of side, elevation views of the example aircraft of FIG. 1 during a transition process from the wing-borne flight regime to the thrust-borne flight regime.

FIG. 8 is a schematic view of a trim control system for an aircraft with a scheduled angle of attack according to an example embodiment of the present disclosure.

FIG. 9 is a graph of nominal shaft angle versus normalized air speed for various angles of attack according to an example embodiment of the present disclosure.

FIG. 10 is an angle of attack schedule according to an example embodiment of the present disclosure.

FIG. 11 is an average propeller pitch schedule according to an example embodiment of the present disclosure.

FIG. 12 is a longitudinal control input schedule according to an example embodiment of the present disclosure.

FIGS. 13A and 13B are flowcharts of trim control methods for an aircraft with a scheduled angle of attack according to an example embodiment of the present disclosure.

FIG. 14 is a diagram of example computing components according to an example embodiment of the present disclosure.

Repeat use of reference characters in the present specification and drawings is intended to represent the same or analogous features or elements of the present invention.

### DETAILED DESCRIPTION

Advancements in electric motors and batteries have given rise to aircraft configurations that include redundant, high-torque, high-bandwidth propulsion units—some units having additional degrees of freedom, such as tilting or thrust vectoring—resulting in a system that is overactuated. Consequently, it is not straightforward to determine the most advantageous trim conditions for the aircraft as the aircraft flies through multiple flight regimes. Properly trimming the aircraft can improve acoustics and/or improve power efficiency.

In example aspects, control systems and control methods of the present disclosure can provide a trim scheduler for an aircraft that receives operational data, such as sensor data and/or pilot commands, and generates the desired trim values for input into a flight controller. In particular, the trim scheduler may receive various inputs, such as commanded longitudinal acceleration, commanded normal acceleration, and airspeed. The trim scheduler may use the inputs to select a single set of trim values dynamically for any point in time. The output of the trim scheduler may include angle of attack, as well as various actuator commands, such as tilt angles, propeller rotational speeds, propeller pitch angles, desired propulsor torques/thrusts, and/or control surface deflections.

In certain example embodiments, the trim scheduler provides trimmed angle of attack and/or trimmed tilt angle that were determined offline in order to improve flight performance and improve acoustics across one or more flight regimes (e.g., in the case of vertical takeoff and landing aircrafts, the flight regimes include thrust-borne flight, transitional flight, and wing-borne flight). Because the aircraft model may be underdetermined, scheduling angle of attack and other trim parameters may constrain the system to provide a single trim solution. Additionally, the trim scheduler may include an array of trim maps, each trim map corresponding to a different operational state. For example, separate trim maps may be provided for the nominal operational state and various off-nominal or failure modes, such as inoperable propulsion units or batteries.

In example aspects, control systems and control methods of the present disclosure may be particularly configured for use in or with tilt propeller aircraft, which differ from tiltrotor aircraft. For instance, tilt propeller aircraft may include relatively small, rigid propellers rather than the relatively larger, elastic proprotors in tiltrotor aircraft. Tilt propeller aircraft can be configured to control pitch attitude control via multiple thrust sources arrayed longitudinally about the tilt propeller aircraft and may not include cyclic pitch control as in tiltrotor aircraft. The relatively small, rigid propellers of tilt propellers may advantageously reduce aeroelastic challenges and blade flapping constraints of tiltrotors, and the lack of cyclic pitch significantly may advantageously reduce complexity of the propeller hubs of tilt propellers relative to tiltrotors. It will be understood that the control systems and control methods of the present disclosure may be used in or with other aircraft configured for vertical take-off and horizontal flight, including tiltrotor aircraft.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

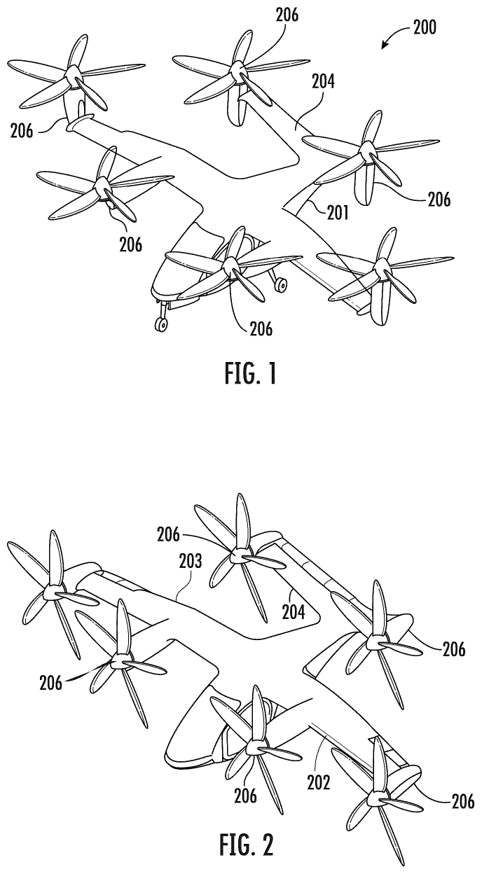

FIGS. 1 and 2 are perspective views of an aircraft 200 configured for vertical take-off and landing as well as horizontal flight according to an example embodiment of the present disclosure. In FIG. 1, aircraft 200 is in a thrust-borne flight regime or hover configuration. In FIG. 2, the aircraft 200 is in a wing-borne flight regime or high-speed configuration. As shown in FIGS. 1 and 2, the aircraft 200 may include tilt propulsion units 206 with bladed propellers powered by electric motors. The tilt propulsion units 206 may provide thrust during take-off and forward flight of the aircraft 200. Moreover, the tilt propulsion units 206 may be rotated relative to fixed wings of the aircraft 200 between the thrust-borne flight regime shown in FIG. 1 and the wing-borne flight regime shown in FIG. 2.

In the thrust-borne flight regime, the propellers of the tilt propulsion units 206 may be oriented to primarily or predominately provide vertical thrust for take-off and landing. In the wing-borne flight regime, the propellers of the tilt propulsion units 206 may be oriented to primarily or predominately provide forward thrust for high-speed flight. It will be understood that in alternative example embodiments, the wings of the aircraft 200 may rotate, with the leading edges of the wings facing upwards, such that the propellers of the tilt propulsion units 206 provide vertical thrust for takeoff and landing. In example embodiments, both the electric motor and the propellers of the tilt propulsion units 206 may be together rotated when the aircraft 200 adjusts between the thrust-borne flight regime of FIG. 1 and the wing-borne flight regime of FIG. 2. Thus, the tilt propulsion units 206 may allow for directional change of thrust without requiring any gimbaling, or other method, of torque drive around or through a rotating joint.

In some example aspects, the aircraft 200 take offs from the ground with vertical thrust from the tilt propulsion units 206 in the thrust-borne flight regime. As the aircraft 200 gains altitude, the tilt propulsion units 206 may begin to tilt forward in order to begin forward acceleration. As the aircraft 200 gains forward speed, airflow over the wings results in lift, such that the tilt propulsion units 206 become less important and then unnecessary for maintaining altitude using vertical thrust. Once the aircraft 200 reaches sufficient forward speed, the tilt propulsion units 206 may be oriented to provide forward thrust in the wing-borne flight regime, and the aircraft 200 may continue to gain speed.

As shown in FIGS. 1 and 2, the aircraft 200 may include an aircraft body 201 and fixed wings 202, 203, which may be forward swept wings, including a left wing 202 and a right wing 203. At least some of tilt propulsion units 206 may be mounted on the wings 202, 203. As noted above, the tilt propulsion units 206 may include electric motors and propellers, which are configured to articulate between the thrust-borne flight regime shown in FIG. 1 and the wing-borne flight regime shown in FIG. 2.

The tilt propulsion units 206 on wings 202, 203 may be articulated by deployment mechanisms, which may reside in nacelle bodies, and which deploy the motor and propeller while all or most of the nacelle remains in place attached to the wings 202, 203. In example embodiments, the deployment mechanisms for the tilt propulsion units 206 may include the linkages and/or nacelle/boom pivots described in U.S. Pat. Nos. 10,974,827 and/or 10,315,760, both of which are incorporated herein in their entirety by reference. The tilt propulsion units 206 at the tips or distal ends of the wings 202, 203 may be articulated by rotating along a pivot axis such that the nacelle, the electric motor, and the propeller deploy in unison.

The aircraft body 201 may extend rearward and be attached to raised rear stabilizers 204. At least some of tilt propulsion units 206 may also be attached to the rear stabilizers 204. The tilt propulsion units 206 on the rear stabilizers 204 may be articulated between the thrust-borne flight regime shown in FIG. 1 and the wing-borne flight regime shown in FIG. 2 by rotating along a pivot axis such that the nacelle, the electric motor, and the propeller deploy in unison.

The tilt propulsion units 206 may be positioned at different distances from the aircraft center of mass in two axes. Thus, e.g., attitude control during vertical take-off and landing in the thrust-borne flight regime may be manipulated by varying the thrust at each of the tilt propulsion units 206 locations. It will be understood that the arrangement of tilt propulsion units 206 on wings 202, 203 is provided by way of example and that other arrangements may be utilized. For instance, the aircraft 200 in FIGS. 1 and 2 includes one mid-span propulsion unit 206 on each wing 202, 203 and includes one wingtip propulsion unit 206 on each wing 202, 203. In alternative example embodiments, one or more additional mid-span tilt propulsion units 206 may be utilized.

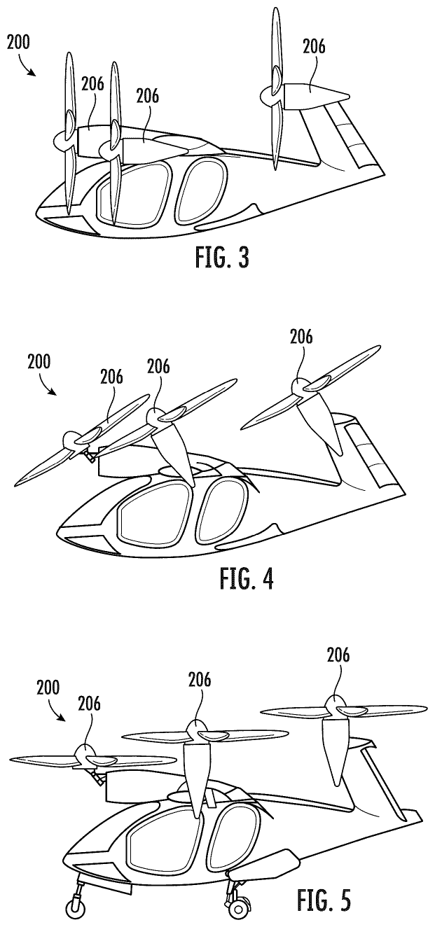

FIG. 3 shows the aircraft 200 in the wing-borne flight regime. In the wing-borne flight regime, the tilt propulsion units 206 are positioned and oriented to provide forward thrust during horizontal flight. The centers of mass of the motors and of the propellers of the tilt propulsion units 206 on the wings 202, 203 may be forward of the leading edge of the wings 202, 203 in the wing-borne flight regime. The tilt propulsion units 206 on the rear stabilizers 204 may be at a different elevation than the tilt propulsion units 206 the wings 202, 203.

The aircraft 200 may also include any suitable set of flight actuators, which functions to transform aerodynamic forces/moments of the aircraft to affect aircraft control. Flight actuators may include control surface actuators (e.g., configured to drive control surfaces), tilt linkages (e.g., which actuate the tilt propulsion units 206 between the forward flight and hover configurations), variable blade pitch actuators (e.g., for variable blade pitch for the propellers of the tilt propulsion units 206), and/or any other suitable actuators. Control surfaces may include flaps, elevators, ailerons, rudders, ruddervators, spoilers, slats, air brakes, and/or any other suitable control surfaces. In example embodiments, the control surfaces may include the high-lift mechanisms described in U.S. Pat. No. 11,292,581, which is incorporated in its entirety by reference.

The tilt propulsion units 206 may include blade pitching mechanisms configured to change an angle of attack of the blades of the propellers of the tilt propulsion units 206 (e.g., relative to a disc plane). The blade pitching mechanism may allow independent articulation of each blade, collective articulation of the blade pitch (e.g., simultaneous), and/or otherwise suitably allow articulation. The blade pitching mechanism may include a rotary plate mechanism (e.g., swashplate) and/or linkage which extends through an interior of the motor. However, in some example embodiments, the tilt propulsion units 206 are not configured for cyclic pitch control.

In the example shown in FIGS. 1 through 5, the aircraft 200 may include two passenger seats side by side, as well as landing gear under the aircraft body 201. Although aircraft 100 is shown as a two-passenger aircraft, other numbers of passengers may be accommodated in other example embodiments of the present disclosure. The landing gear (e.g., retractable landing gear, fixed landing gear) may be configured to structurally support the aircraft 200 when the aircraft 200 is in contact with the ground and/or maneuver the aircraft 200 during taxi.

It will be understood that the aircraft 200 is provided by way of example. The present subject matter may also be used in or with other aircraft in alternative example embodiments. For example, the present subject matter may be used in or with VTOL aircraft, multi-modal aircraft, and/or a tilt propeller aircraft. The propulsion units may have a fixed or variable pitch. The aircraft may include an all-electric powertrain, e.g., with battery powered electric motors, for the propulsion units. In alternative example embodiments, may include a hybrid powertrain, such as a gas-electric hybrid with an internal-combustion generator, or an internal-combustion powertrain, such as a gas-turbine engine, a turboprop engine, etc. The present subject matter may be used in or with conventional take-off and landing aircraft, particularly those with distributed electric propulsion.

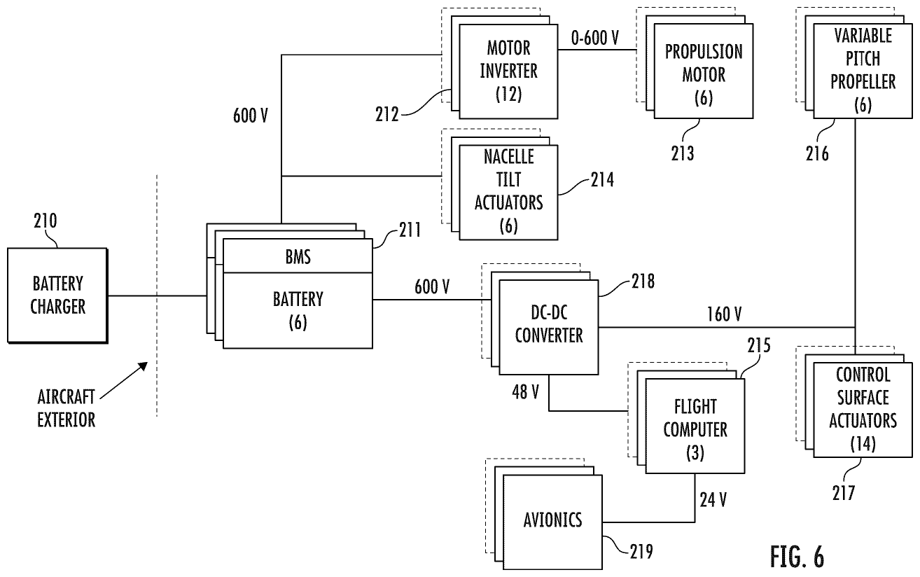

FIG. 6 is schematic view of an electrical system for the aircraft 200. As shown, the electrical system may include batteries 211, e.g., six (6) batteries 211. In an example, each of the batteries 211 may supply two power inverters 212. Thus, an example implementation of the electrical system may include twelve (12) power inverters 212. The nominal voltage of the batteries may be six hundred volts (600V) in example embodiments. Each of the propulsion motors 213 may include two sets of windings, with each motor 213 powered by two inverters 212, one for each set of windings. The two inverters 212 powering a single motor 213 each may be supplied power by different batteries 211. In addition to supplying power to the motor inverters 212, the battery 211 may also supply power to tilt actuators 214, such as tilt actuators, which are used to deploy and stow the tilt propulsion units 206 during various flight modes, such as the thrust-borne flight regime (FIG. 3), the wing-borne flight regime (FIG. 5), and transition between (FIG. 4).

A flight computer 215 may monitor the current from each of the motor inverters 212, which are supplying power to the winding sets in the motors 213. The flight computer 215 may also control the motor current supplied to each of the windings of the motors 213. In example embodiments, the batteries 211 may also supply power to blade pitch motors 216 and position encoders of the tilt propulsion units 206. The batteries 211 may also supply power to one or more actuators 217, such as control surface actuators configured to adjust the position of various control surfaces on the aircraft 200.

The blade pitch motors 216 and the actuators 217 may receive power through a DC-DC converter 218, which may step the voltage from six hundred volts (600V) to one hundred and sixty volts (160V), for example. A suite of avionics 219 may also be coupled to the flight computer 215. A battery charger 210 may be used to recharge the batteries 211, and the battery charger 210 may be located external to the aircraft 200 and ground based.

In example variants, the flight computer 215 may be implemented and communicatively connected within the power architecture as described in U.S. Pat. No. 11,323,214, which is incorporated in its entirety by reference. In a specific example, a first set of batteries (e.g., doublet pair) may power a first switch set, and a second set of batteries (e.g., separate and distinct from the first set, remainder of the batteries, second doublet pair, etc.) may power a second switch set, and the first and second switch sets may communicatively connect the flight computers to the flight actuators. The compensations to power distribution to the various motors from the various batteries, as described above, may be done autonomously and onboard the aircraft. The compensations may be done without needing input from the pilot, for example.

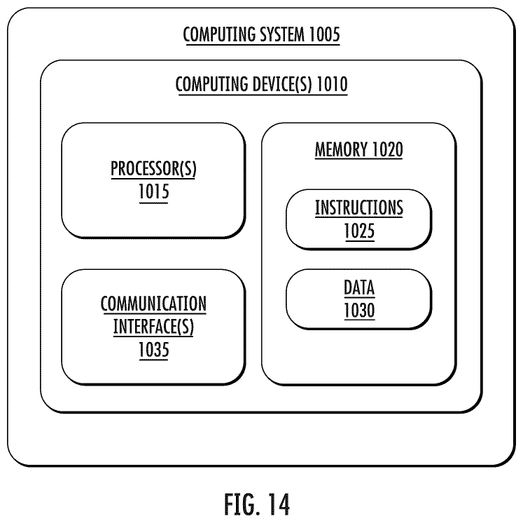

The flight computer 215 may be configured to generate commands that may be transmitted to and interpreted by the inverters 212 and/or actuators 217 to control aircraft flight. In example embodiments with a plurality of flight computers 215, each of the flight computers 215 may be a substantially identical instance of the same computer architecture and components, but can additionally or alternatively be instances of distinct computer architectures and components (e.g., generalized processors manufactured by different manufacturers). The flight computers 215 may include CPUs, GPUs, TPUs, ASICs, microprocessors, and/or any other suitable set of processing systems. In example embodiments, each of the flight computers 215 performs substantially identical operations (e.g., processing of data, issuing of commands, etc.) in parallel, and are connected (e.g., via the distribution network) to the same set of flight components. In example embodiments, the output of each flight computer 215 is provided to the tilt propulsion units 206 and/or actuators 217 by way of a data distribution network, e.g., as described in U.S. Pat. No. 11,323,214, which is incorporated in its entirety by reference. FIG. 14 provides additional detail regarding example components of a computing system, such as a flight computer 215.

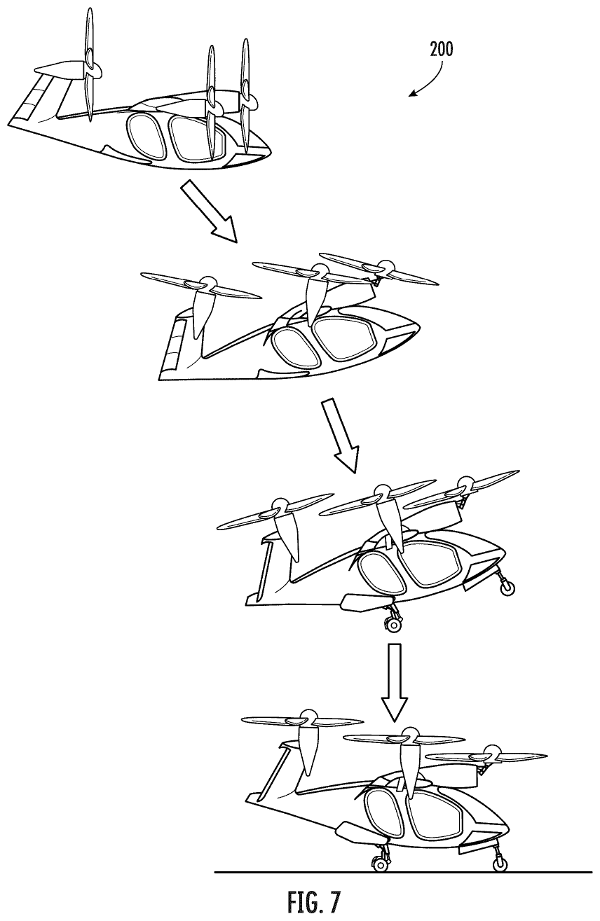

The flight computer 215 may be programmed to assist control operation of the aircraft 200. For example, as further described herein, the flight computer 215 may be programmed to help control the aircraft 200 during transitional states from forward to vertical thrust (e.g., for landing), as depicted in FIG. 7, or vice versa (e.g., for take-off).

As will now be described in greater detail, the flight computer 215 may be programmed to implement certain control systems for controlling operation of the aircraft 200 by using operational data, such as sensor data and/or pilot commands, and selecting (e.g., and computing) desired trim values for the aircraft 200.

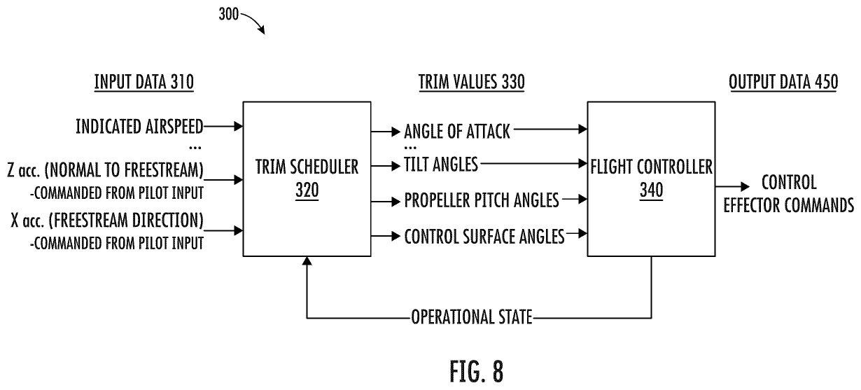

FIG. 8 is a schematic view of a control system 300 for an aircraft according to an example embodiment of the present disclosure. It will be understood that only relevant portions of the complete control system for an aircraft is shown in FIG. 8. Other components are omitted for the sake of brevity. Thus, the control system 300 may include additional control components in other example embodiments. The control system 300 in FIG. 8 may be implemented as at least a portion of, or otherwise be in communication with, the flight computer 215. Control system 300 is described in greater detail below in the context of the aircraft 200, which was described with reference to FIGS. 1 through 7. In this regard, the motors 213, the motor inverters 212, the tilt actuators 214, blade pitch motors 216, and/or actuators 217 of the aircraft 200 may be adjusted by the control system 300 to assist with trimming the aircraft 200 and/or implementing control commands from a pilot. However, it will be understood that the control system 300 may be used in or with other aircraft in alternative example embodiments. As noted above, aircraft 200 has variety of control effectors, which can result in an underdetermined system. As discussed in greater detail below, the control system 300 may assist with properly trimming the aircraft 200, which may advantageously improve acoustics and/or improve power efficiency.

In example embodiments, the control system 300 may be programmed or configured with one or more subsystems. Each subsystem of the control system 300 may be configured as a packaged functional hardware unit or a software program that performs a particular function or series of related functions. For instance, the subsystems may be self-contained hardware or software components for the performing the operations, and implementing the components, shown in FIG. 8.

As shown in FIG. 8, the control system 300 may include a trim scheduler 320 and a flight controller 340. The trim scheduler 320 and flight controller 340 of control system 300 may be implemented on the flight computers 215. For instance, trim scheduler 320 and flight controller 340 may be configured as separate subsystems. It will be understood that other implementations of trim scheduler 320 and flight controller 340 may also be utilized.

As shown, control system 300 may access input data 310. The input data 310 may be indicative of one or more inputs for the trim scheduler 307. For example, an input may include an airspeed of the aircraft 200. The airspeed may be at least one of an indicated airspeed, a calibrated airspeed, an equivalent airspeed, or a true airspeed. The airspeed of the aircraft 200 may be measured via a suitable sensor and optionally corrected via conventional methods.

In some example implementations, the input data 310 may indicate a commanded normal acceleration of the aircraft 200 (e.g., a Z-axis acceleration) and/or a commanded longitudinal acceleration (e.g., an X-axis acceleration). In example embodiments, the commanded longitudinal acceleration and commanded normal acceleration may be computed based at least in part on pilot inputs, e.g., via a unified flight control strategy, such as the control strategy described in U.S. Pat. No. 10,983,534, which is incorporated in its entirety by reference. In certain example implementations, the input data 310 may indicate a measured normal acceleration of the aircraft 200 (e.g., a Z-axis acceleration) and/or a measured longitudinal acceleration (e.g., an X-axis acceleration), e.g., from sensors of the aircraft 200.

Within control system 300, the trim scheduler 320 may access the input data 310. For example, the trim scheduler 320 may receive the input data 310 from various sources, such as sensors, pilot control systems, etc. The input data 310 may be stored in a database or memory onboard the aircraft 200. The input data 310 may be accessed through one or more computing operations for obtaining stored data, including requests, retrieval, push, pull, etc.

The trim scheduler 320 may determine trim values 330 based on the input data 310. Determining the trim values 330 may include computing the trim values by processing the input data 310 (e.g., using the aircraft's onboard computing hardware) based on certain algorithms, models, equations, or other operations/functions programmed within the trim scheduler 320. The trim values 330 may include various trim states for the aircraft 200. For example, the trim values 330 may include one or more of an angle of attack trim value for the aircraft 200, a respective tilt angle trim value for each propulsion unit 206, a respective rotational speed for each propulsion unit 206, a respective propeller pitch angle for each propulsion unit 206, a respective expected torque for each propulsion unit 206, and a respective angle for each control surface of the aircraft 200. It will be understood that the examples provided above are not limiting and that, in other example embodiments, the trim values 330 may include other trim states for the aircraft 200 in addition to or as an alternative to the example trim values listed above.

In example embodiments, the trim scheduler 320 may utilize one or more predetermined schedules or trim maps to compute the trim values 330 based on the input data 310. The schedules may be located within memory accessible by the trim scheduler 320. Thus, the schedules may be determined offline. In example embodiments, the trim scheduler 320 may utilize a look-up table or other function to access predetermined trim values 330.

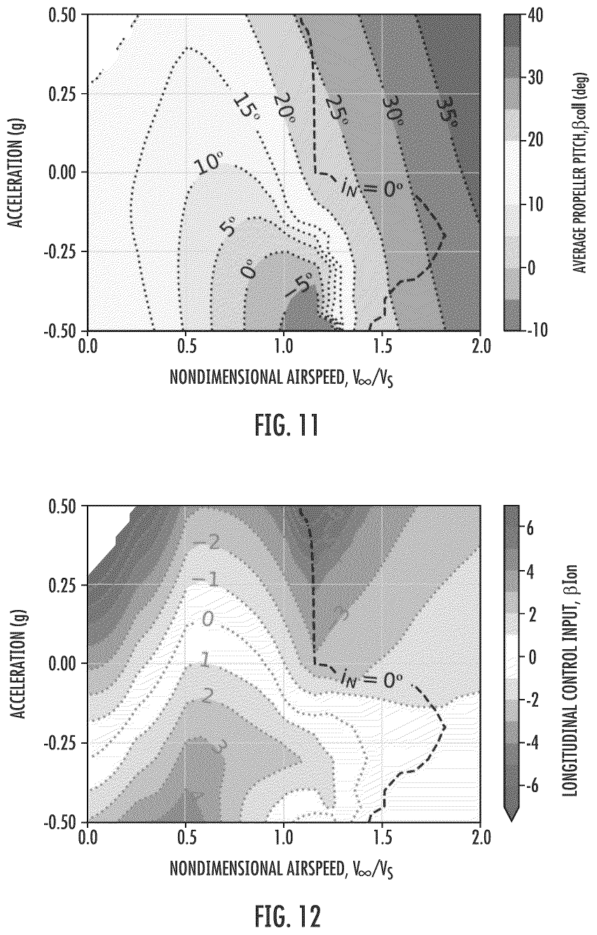

With reference to FIGS. 10-12, schedules for angle of attack (FIG. 10), average propeller pitch (FIG. 11), and longitudinal control input (FIG. 12) may be utilized by the trim scheduler 320 to computationally determine the trim values 330. For instance, the angle of attack for aircraft 200 for a particular point in time may be computed from the schedule for angle of attack in FIG. 10 by identifying the angle of attack trim value associated with the intersection of the longitudinal acceleration and the airspeed from the input data 310. Thus, e.g., the scheduled angle of attack trim value in FIG. 10 is six degrees (6°) for a normalized airspeed of 1.5 and longitudinal acceleration of negative one-half gravitational force equivalent (−0.5 g). Other angle of attack trim values result from different airspeeds and accelerations as may be seen in FIG. 10.

The average propeller pitch trim value schedule in FIG. 11 and the longitudinal control input trim value schedule in FIG. 12 may be used in a similar manner to determine other trim values 330, namely scheduled propeller pitch trim value and scheduled longitudinal control input trim value, at the particular point in time. For example, the scheduled average propeller pitch trim value in FIG. 11 is about twenty-two and a half degrees (22.5°) and the scheduled longitudinal control input trim value in FIG. 12 is about one for a normalized airspeed of 1.5 and longitudinal acceleration of negative one-half gravitational force equivalent (−0.5 g). Other average propeller pitch trim values and longitudinal control input trim values result from different airspeeds and accelerations as may be seen in FIGS. 11 and 12.

In certain example embodiments, the trim scheduler 320 may compute one or more of the trim values 330 in real time during operation of the aircraft 200. For example, the trim scheduler 320 may compute the one or more of the trim values 330 using a model of the aircraft 200, e.g., rather than the predetermined schedules. Moreover, in example embodiments, the trim scheduler 320 may utilize predetermined schedule(s) to determine one or more of the trim values 330 (such as angle of attack and/or tilt angle) based on the input data 310, and the trim scheduler 320 may compute the remaining trim values 330 based on the input data 310. In certain example embodiments, the model of the aircraft 200 may be stored in a database or memory onboard the aircraft 200, and the model may be updated as configurations of the aircraft 200 change.

The trim scheduler 320 may include schedules for an array of operational states of the aircraft 200. For example, the trim scheduler 320 may include respective schedules for nominal operational state and various off-nominal or failure modes of the aircraft 200. As shown in FIG. 8, the flight controller 340 may determine the operational state of the aircraft 200, and the trim scheduler 320 may access the current operational state of the aircraft 200 and select the corresponding schedule to determine one or more of the trim values 330 based on the input data 310.

In example embodiments, the trim scheduler 320 may include a schedule for the nominal operational state of aircraft 200, a respective schedule for when each propulsion unit 206 is inoperable or off-nominal, a respective schedule for when battery 211 is inoperable or off-nominal, a respective schedule for when one or more of the tilt actuators 214, the blade pitch motors 216, and the actuators 217 of the aircraft 200 are inoperable or off-nominal, a respective schedule for when one or more sensors, such as an airspeed sensor, an acceleration sensor, etc., is inoperable. Thus, the trim scheduler 320 may determine the trim values 330 during various operational states of the aircraft 200, including nominal and off-nominal operational states. As another example, the trim scheduler 320 may include respective schedules for various payload conditions of aircraft 200, such a respective schedule for when the aircraft 200 is at one hundred percent (100%) load capacity, seventy-five percent (75%) load capacity, fifty percent (50%) load capacity, twenty-five percent (25%) load capacity, etc. As another example, the trim scheduler 320 may include a schedule for various environmental conditions, such as a high noise area or a low noise area, and the trim scheduler 320 may include respective schedules for high noise areas, in which higher noise, higher efficiency operation may be desirable, and low noise areas, in which lower noise, lower efficiency operation may be desirable. As another example, the trim scheduler 320 may include respective schedules for when the remaining capacity of batteries 211 is less than a threshold such that operation of the aircraft 200 with maximum efficiency is desirable. Other schedules are also within the scope of the present disclosure. As noted above, the flight controller 340 may determine the operational state of the aircraft 200, e.g., whether one or more of tilt propulsion units 206 is inoperable or off-nominal, one or more of batteries 211 is inoperable or off-nominal, etc., and the trim scheduler 320 may access the current operational state of the aircraft 200 and select the corresponding schedule to determine one or more of the trim values 330 based on the input data 310.

The angle of attack trim values selected by the trim scheduler 320 may be within a range of angle of attack trim values. For example, the angle of attack trim values may be no greater than twelve degrees (12°) and no less than negative twelve degrees (−12°). Such range may provide a practical range of angles of attack for aircraft 200 will also providing suitable margins to stall.

With reference again to FIG. 10, the angle of attack schedule used by the trim scheduler 320 may include a set of angle of attack trim values that vary monotonically. Thus, the angle of attack schedule may include a monotonic set of angle of attack trim values. By varying monotonically, vacillation of the angle of attack for the aircraft 200 during acceleration of the aircraft, which can be disorienting to pilots and/or uncomfortable to passengers, can be avoided. As used herein, the term “monotonic” may include substantially monotonic such that angle of attack trim values vary in a manner that avoids or reduces vacillation of the angle of attack for the aircraft 200. Thus, the angle of attack trim values may not be perfectly monotonic in certain example embodiments but may allow variations that do not result in vacillation of the angle of attack for the aircraft 200 that disorients pilots and/or is uncomfortable to passengers.

In example embodiments, the angle of attack trim values may be ordered within the monotonic set such that the angle of attack trim values are inversely related with the airspeed of the aircraft 200 in the transition flight regime. Thus, e.g., the angle of attack trim values may be ordered within the set such that the angle of attack trim values increase as the airspeed of the aircraft decreases in the transition flight regime. Thus, in the transition flight regime, the monotonic set of angle of attack trim values may provide relatively low value angle of attack trim values when the airspeed is relatively high due to the lifting ability as the wings 202, 203 at the relatively high airspeeds, and the monotonic set of angle of attack trim values may provide relatively high value angle of attack trim values when the airspeed is relatively low to increase the lift coefficient of the wings 202, 203 at the relatively low airspeeds.

In example embodiments, the trim scheduler 320 may compute the angle of attack trim value by selecting the angle of attack trim value from the set of angle of attack trim values such that the, e.g., longitudinal or adjusted longitudinal, acceleration of aircraft 200 is continuous and constant as the airspeed changes in a nominal flight path of the transition flight regime. Selecting the angle of attack trim value such that the acceleration of aircraft 200 is continuous and constant in the nominal flight path may be particularly advantageous during the conversion process of shown in FIG. 7 between the wing-borne flight regime and the thrust-borne flight regime. As an example, the longitudinal or adjusted longitudinal acceleration of the aircraft 200 may be no greater than one-half gravitational force equivalent (0.5 g) and no less than negative one-half gravitational force equivalent (−0.5 g) during the transition. Selecting the angle of attack trim value to maintain the acceleration of aircraft 200 as continuous and constant during the nominal flight path of the transition may advantageously assist with providing a comfortable ride for passengers in aircraft 200, particularly during transport and similar operations. Due to the underdetermined nature of the system, the set of angle of attack trim values may also be selected by considering the negative of the average angle of attack over a trajectory of the aircraft 200 to arrive at a single solution.

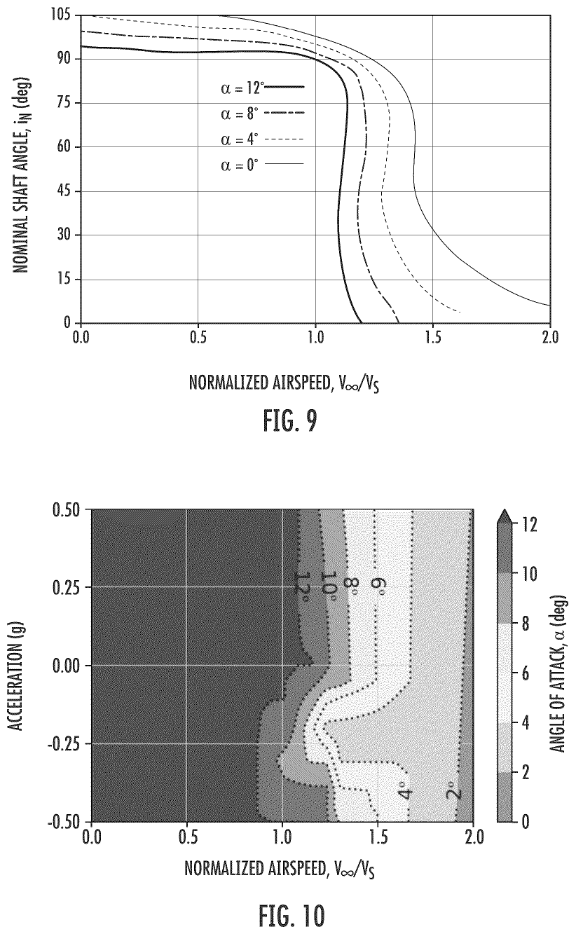

In example embodiments, the trim scheduler 320 may select tilt angle trim values for the propulsion units 206 such that tilt angle trim values change within tilt rate limits for the tilt propulsion units 206. As shown in FIG. 9, the nominal shaft angle of the tilt propulsion units 206 changes rapidly when the normalized airspeed of the aircraft 200 is greater one (1.0) at fixed angles of attack. Moreover, one of ordinary skill in the art would understand that keeping the angle of attack fixed as in FIG. 9 while maintaining constant acceleration would require the tilt propulsion units 206 to be capable of very fast tilt rates, which can be impracticable in certain implementations. Thus, to allow the tilt propulsion units 206 to operate with reasonable tilt rate performance, the tilt angle trim values for the propulsion units 206 may be ordered within a schedule such that the tilt angle trim values for the propulsion units 206 change within and/or do not exceed tilt rate limits for the tilt propulsion units 206. For example, the tilt rate limit for the tilt propulsion units 206 may be no greater than ten degrees per second (10 deg/s). As another example, the tilt angle trim values for the propulsion units 206 may be ordered within a schedule such that a peak tilt rate magnitude, |Δiₙ/ΔV_{∞}|, for each tilt propulsion unit 206 is, e.g., substantially, minimized.

Turning back to FIG. 8, the flight controller 340 may access data indicative of the trim values 330. For example, the flight controller 340 may receive the trim values 330 from the trim scheduler 320. The flight controller 340 may compute output data 450 based at least in part on the trim values 330. The output data 450 may include control effector commands or actuator commands. The commands may include signals encoded with data or instructions for operating a component of the aircraft 200. This can include, for instance, motor speed, pitch angle, tilt angle, control surface deflections, etc. The flight controller 340 may determine control commands for one or more of the motors 213, the motor inverters 212, the tilt actuators 214, the blade pitch motors 216, and the actuators 217 of the aircraft 200 based at least in part on the trim values 330. The output data 450 may be implemented by such components of the aircraft 200 in order to stabilize the aircraft 200 and/or implement control commands from a pilot. Thus, the flight controller 340 may control operation of the aircraft 200 based at least in part on the trim values 330. By way of example, at each point in time during operation of the aircraft 200, the trim scheduler 320 may use the input data 310 to dynamically compute a single set of trim values 330 for the aircraft 200. The trim values 330 may include the angle of attack for the aircraft 200, as well as various actuator commands, such as tilt angles, propeller rotational speeds, propeller pitch angles, desired propulsor torques/thrusts, and/or control surface deflections.

Control system 300 may operate in any flight condition of aircraft 200 to provide trim values 330. In example embodiments, control system 300 may be particularly useful during a transition of the aircraft 200 from the thrust-borne flight regime to the wing-borne flight regime or vice versa. With reference to FIG. 7, aircraft 200 is shown adjusting from the wing-borne flight regime to the thrust-borne flight regime. As shown, the angle of attack of the aircraft 200 varies during the transition, and control system 300 selects the angle of attack trim value during the transition. Using control system 300 to select the angle of attack trim value can advantageously provide a high-performance trim strategy for the aircraft 200 during the transition, e.g., by reducing acoustics and/or improving power efficiency. Thus, in example embodiments, the trim scheduler 320 may access the input data 310 during the transition of the aircraft 200 from the thrust-borne flight regime to the wing-borne flight regime or vice versa during the transition.

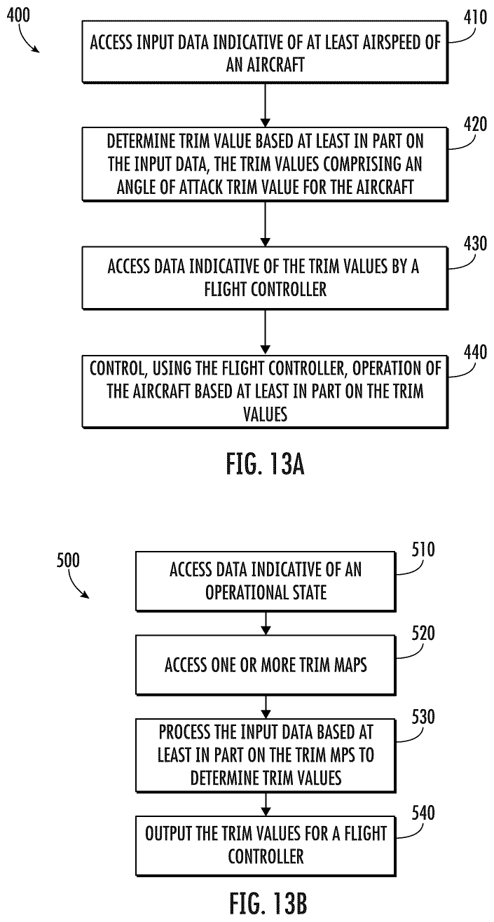

FIG. 13A illustrates a method 400 for controlling an aircraft according to example implementations of the present disclosure. One or more portions of the method 400 may be implemented by one or more computing devices such as for example, the computing devices/systems described in reference to the other figures. Moreover, one or more portions of the method 400 may be implemented as an algorithm on the hardware components of the device/systems described herein. For example, a computing system may include one or more processors and one or more non-transitory, computer-readable media storing instructions that are executable by the one or more processors to perform operations, the operations including one or more of the operations/portions of method 400.

FIG. 13A depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

Method 400 is described in greater detail below in the context of the aircraft 200. However, it will be understood that method 400 may be used in or with other aircraft and control systems to provide trim values for an aircraft as the aircraft flies through multiple flight regimes.

At 410, a computing system (e.g., control system 300) may access input data, such as the input data 310. The input data may be indicative of at least the airspeed of the aircraft 200. In some implementations, the input data may be indicative of at least one of: a commanded longitudinal acceleration or a commanded normal acceleration. In other implementations, the input data may be indicative of at least one of: a measured longitudinal acceleration or a measured normal acceleration. The accelerations may be, for example, provided by a pilot of the aircraft or by sensor feedback.

At 420, the computing system may determine trim values, such as the trim values 330, based at least in part on the input data from 410. The trim values may include an angle of attack trim value for the aircraft 200. The trim values may also include a respective tilt angle trim value for each propulsion unit 206, a respective rotational speed for each propulsion unit 206, a respective propeller pitch angle for each propulsion unit 206, a respective expected torque for each propulsion unit 206, and a respective angle for each control surface of the aircraft 200.

By way of example, FIG. 13B illustrates a method 500 for computing trim values according to example, implementations of the present disclosure. One or more portions of the method 400 may be implemented by one or more computing devices such as for example, the computing devices/systems described in reference to the other figures. Moreover, one or more portions of the method 500 may be implemented as an algorithm on the hardware components of the device/systems described herein. For example, a computing system may include one or more processors and one or more non-transitory, computer-readable media storing instructions that are executable by the one or more processors to perform operations, the operations including one or more of the operations/portions of method 500.

At 510, the computing system (e.g., using the trim scheduler 320 and/or the flight controller 330) may access operational state data. For example, the computing system may determine the operational state of the aircraft, e.g., whether one or more of tilt propulsion units is inoperable or off-nominal, one or more of batteries is inoperable or off-nominal, one or more actuators are inoperable or off-nominal, a cargo loading of the aircraft, an operating environment of the aircraft, etc. Such operational state data may be determined by the computing system by sensor feedback and/or pilot inputs. The computing system may utilize the operational state data (and its encoded inputs) to select the appropriate trim map for operating the aircraft.

At 520, the computing system (e.g., using the trim scheduler 320) may access one or more trim maps from an accessible memory. The trim maps may include an array of trim maps. Each respective trim map may correspond to a different operational state. For example, a respective trim map may be stored for the nominal operation state of the aircraft. Additional trim maps may be stored for various off-nominal or failure modes. Such mode may be associated with inoperable or off-nominal aircraft components, including inoperable or off-nominal propulsion units, batteries, actuators, etc. The computing system may utilize the operational data (and its encoded inputs) to select the appropriate trim map for operating the aircraft. Thus, at 520, the computing system may select a respective trim map corresponding to the operational state data from 510.

At 530, the computing system (e.g., using the trim scheduler 320) may process the input data based on the trim maps. For instance, using the inputs encoded in the input data, the computing system can use a trim scheduler to traverse the trim maps using a look-up function to determine the trim values. The trim scheduler may receive various inputs, such as commanded longitudinal acceleration, commanded normal acceleration, and airspeed. The trim scheduler may use the inputs to select a single set of trim values dynamically for any point in time.

At 540, the computing system (e.g., the trim scheduler) may output the trim values to a flight controller. For instance, the output of the trim scheduler may include angle of attack, as well as various actuator commands, such as tilt angles, propeller rotational speeds, propeller pitch angles, desired propulsor torques/thrusts, and/or control surface deflections. As described herein, the trim scheduler may provide trimmed angle of attack and/or trimmed tilt angle that were determined offline in order to improve flight performance and improve acoustics, e.g., by reducing acoustic impact/signature of the aircraft. Scheduling angle of attack and other trim parameters may constrain the system to provide a single trim solution for the aircraft.

Returning, to FIG. 13A, at 430, method 400 may include accessing data indicative of the trim values by the flight controller. This may include a direct communication from the trim scheduler or accessing an intermediate storage that includes a data structure indicative of the computed trim values.

At 440, the computing system may adjust operation of the aircraft 200 based at least in part on the trim values from 420. For example, the computing system may determine and output control commands for one or more of the motors 213, the motor inverters 212, the tilt actuators 214, the blade pitch motors 216, and the actuators 217 of the aircraft 200 based at least in part on the trim values from 420.

FIG. 10 depicts example system components of a computing system 1005 according to example implementations of the present disclosure. The computing system 1005 may include one or more computing devices 1010. The computing devices 1010 of the computing system 1005 may include one or more processors 1015 and a memory 1020. The processors 1015 can be any suitable processing device (e.g., a processor core, a microprocessor, an ASIC, a FPGA, a controller, a microcontroller, etc.) and may be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 may store information that can be accessed by the processors 1015. For instance, the memory 1020 (e.g., one or more non-transitory computer-readable storage mediums, memory devices) may include computer-readable instructions 1025 that can be executed by the processors 1015. The instructions 1025 may be software written in any suitable programming language or may be implemented in hardware. Additionally, or alternatively, the instructions 1025 may be executed in logically or virtually separate threads on processors 1015.

For example, the memory 1020 may store instructions 1025 that when executed by the processors 1015 cause the processors 1015 to perform operations such as any of the operations and functions of any of the computing systems (e.g., aircraft system) or computing devices (e.g., the flight computer), as described herein.

The memory 1020 may store data 1030 that can be obtained, received, accessed, written, manipulated, created, or stored. The data 1030 may include, for instance, input data, trim values, output data, or other data/information described herein. In some implementations, the computing devices 1010 may access from or store data in one or more memory devices that are remote from the computing system 1005.

The computing devices 1010 can also include a communication interface 1035 used to communicate with one or more other systems. The communication interface 1035 may include any circuits, components, software, etc. for communicating via one or more networks. In some implementations, the communication interface 1035 may include for example, one or more of a communications controller, receiver, transceiver, transmitter, port, conductors, software or hardware for communicating data/information.

FIG. 10 illustrates one example computing system 1005 that may be used to implement the present disclosure. Other computing systems can be used as well. Computing tasks discussed herein as being performed at computing devices onboard the aircraft may instead be performed remote from the aircraft (e.g., a network connected computing system), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

As may be seen from the above, the present subject matter may advantageously provide control systems and control methods for aircraft, such as aircraft configured for vertical take-off and landing as well as horizontal flight. The control systems may access input commands for flight path and acceleration, and the control systems may select trim values for the aircraft based on the input commands. The trim values may include an angle of attack for the aircraft as well as shaft angles, pitches, and rotational speeds for propulsion units of the aircraft. In contrast to the complexity of conventional manual pitch attitude modulations, control systems and control methods according to the present disclosure may advantageously provide a straightforward or simple control scheme. Moreover, utilizing the control systems and control methods according to the present disclosure, desirable aircraft configurations for relevant flight conditions during a conversion process from a thrust-borne flight regime and a wing-borne flight regime may be preselected or calculated on-board the aircraft. Thus, difficult aircraft designs with wide conversion corridors that allow pilots to navigate manually can advantageously be avoided. The control systems and control methods according to the present disclosure can be particularly advantageous in aircraft for air taxi and similar operations, e.g., which do not require flexibility in pitch attitude for given trim conditions.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art.

Terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “or” unless otherwise indicated. Also, terms such as “based on” should be understood as “based at least in part on.” As used herein, the terms “first,” “second,” and “third” may be used interchangeably to distinguish one component from another and are not intended to signify location or importance of the individual components. The terms “includes” and “including” are intended to be inclusive in a manner similar to the term “comprising.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

The terms “coupled,” “fixed,” “attached to,” and the like refer to both direct coupling, fixing, or attaching, as well as indirect coupling, fixing, or attaching through one or more intermediate components or features, unless otherwise specified herein.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply embodiments of the disclosure. Hence, specific dimensions and other physical characteristics related to the embodiments disclosed herein are not to be considered as limiting.

1. A method for controlling an aircraft, the method comprising:
accessing input data indicative of at least airspeed of the aircraft;
determining trim values based at least in part on the input data, the trim values comprising an angle of attack trim value for the aircraft;
accessing data indicative of the trim values by a flight controller; and
controlling, using the flight controller, operation of the aircraft based at least in part on the trim values.

2. The method of claim 1, wherein the trim values further comprise a respective tilt angle trim value for each tilt propulsion unit of the aircraft.

3. The method of claim 2, wherein the trim values further comprise at least one of:
a respective rotational speed trim value for each tilt propulsion unit of the aircraft;
a respective propeller pitch angle trim value for each tilt propulsion unit of the aircraft;
a respective expected torque trim value for each tilt propulsion unit of the aircraft; or
a respective angle trim value for each control surface of the aircraft.

4. The method of claim 1, wherein:
flight regimes of the aircraft comprise a wing-borne flight regime, a thrust-borne flight regime, and a transition flight regime; and
controlling operation of the aircraft comprises controlling operation of the aircraft based at least in part on the trim values while the aircraft is in the transition flight regime.

5. The method of claim 1, wherein the input data is further indicative of one or both of commanded longitudinal acceleration and commanded normal acceleration.

6. The method of claim 5, wherein determining the trim values comprises computing the angle of attack trim value based at least in part on the airspeed, the commanded longitudinal acceleration, and the commanded normal acceleration.

7. The method of claim 1, wherein:
flight regimes of the aircraft comprise a wing-borne flight regime, a thrust-borne flight regime, and a transition flight regime; and
determining the trim values comprises computing the angle of attack trim value from a monotonic set of angle of attack trim values that are inversely related with the airspeed in the transition flight regime such that the angle of attack trim values in the monotonic set of angle of attack trim value increase as the airspeed decreases in the transition flight regime.

8. The method of claim 7, wherein the angle of attack trim values in the monotonic set of angle of attack trim values are no greater than twelve degrees and no less than negative twelve degrees.

9. The method of claim 1, wherein determining the trim values comprises computing a tilt rate for each tilt propulsion unit of the aircraft that does not exceed a tilt rate limit for each tilt propulsion unit.

10. The method of claim 1, wherein:
flight regimes of the aircraft comprise a wing-borne flight regime, a thrust-borne flight regime, and a transition flight regime; and
determining the trim values further comprises computing the angle of attack trim value such that a longitudinal acceleration of the aircraft is substantially constant in a nominal flight path of the transition flight regime.

11. The method of claim 10, wherein the longitudinal acceleration of the aircraft is no greater than one-half gravitational force equivalent and no less than negative one-half gravitational force equivalent during the transition.

12. The method of claim 1, wherein each tilt propulsion unit of the aircraft comprises a variable pitch propeller.

13. A system for controlling an aircraft, the system comprising:
one or more processors; and
one or more non-transitory computer-readable media that store instructions that are executable by the one or more processors to perform operations, the operations comprising
accessing input data indicative of at least airspeed of the aircraft,
determining trim values based at least in part on the input data, the trim values comprising an angle of attack trim value for the aircraft, and
controlling operation of the aircraft based at least in part on the trim values.

14. The system of claim 13, wherein the trim values further comprise a respective tilt angle trim value for each tilt propulsion unit of the aircraft.

15. The system of claim 14, wherein the trim values further comprise at least one of:
a respective rotational speed trim value for each tilt propulsion unit of the aircraft;
a respective propeller pitch angle trim value for each tilt propulsion unit of the aircraft;
a respective expected torque trim value for each tilt propulsion unit of the aircraft; or
a respective angle trim value for each control surface of the aircraft.

16. The system of claim 13, wherein controlling operation of the aircraft comprises controlling operation of the aircraft based at least in part on the trim values while the aircraft is in a transition flight regime.

17. The system of claim 16, wherein the input data is further indicative of one or both of commanded longitudinal acceleration and commanded normal acceleration, and determining the trim values comprises computing the angle of attack trim value based at least in part on the airspeed and the commanded longitudinal acceleration, and the commanded normal acceleration.

18. The system of claim 13, wherein determining the trim values comprises computing the angle of attack trim value from a monotonic set of angle of attack trim values that are inversely related with the airspeed in a transition flight regime such that the angle of attack trim values in the monotonic set of angle of attack trim value increase as the airspeed decreases in the transition flight regime.

19. The system of claim 13, wherein:
flight regimes of the aircraft comprise a wing-borne flight regime, a thrust-borne flight regime, and a transition flight regime; and
determining the trim values further comprises computing the angle of attack trim value such that a longitudinal acceleration of the aircraft is substantially constant in a nominal flight path of the transition flight regime.

20. An aircraft, comprising:
a flight controller; and
one or more actuators,
the flight controller comprising one or more processors and one or more non-transitory computer-readable media that store instructions that are executable by the one or more processors to perform operations, the operations comprising:
accessing input data indicative of at least airspeed of the aircraft,
determining trim values based at least in part on the input data, the trim values comprising an angle of attack trim value for the aircraft,
accessing data indicative of the trim values, and
outputting an actuator command for controlling operation of the aircraft, via the one or more actuators, based at least in part on the trim values.
